(19) United States
(12) Patent Application Publication
(10) Pub. No.: US 2025/0280307 A1
(43) Pub. Date: Sep. 4, 2025

(54) RADIO ACCESS NETWORK SYSTEM

(71) Applicants: INVENTEC (PUDONG) TECHNOLOGY CORPORATION, Shanghai (CN); INVENTEC CORPORATION, Taipei City (TW)

(72) Inventors: Shin-Han CHIU, Taipei City (TW); Ke-Hao CHEN, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/742,743

(22) Filed: Jun. 13, 2024

(30) Foreign Application Priority Data
Mar. 4, 2024 (CN) 202410245288.2

(51) Int. Cl. H04W 24/04; H04W 76/10

(52) U.S. Cl. CPC H04W 24/04; H04W 76/10

(57) ABSTRACT

A radio access network system includes: at least one first radio unit and at least one second radio unit. The at least one first radio unit has a first frequency band, and the at least one second radio unit has a second frequency band, wherein a frequency range of the first frequency band and a frequency range of the second frequency band do not overlap with each other, and a first coverage range of the first frequency band at an area and a second coverage range of the second frequency band at the area partially overlap with each other.

### CROSS-REFERENCE TO RELATED APPLICATIONS

This non-provisional application claims priority under 35 U.S.C. § 119(a) on Patent Application No(s). 202410245288.2 filed in China on March, 4, 2024, the entire contents of which are hereby incorporated by reference.

### BACKGROUND

### 1. Technical Field

This disclosure relates to a radio access network system.

### 2. Related Art

The existing 5G private network deployment methods use a set of base stations connecting multiple sets of antennas all over the field to achieve complete coverage. At the same time, multiple sets of user equipment deployed in the field are connected to premise machine. The premise machine transmits data through the user device. The user device then transmits the data to the base station through the antenna, and the base station transmits the data to the core network, and finally, the core network transmits the data to the control center.

However, when the base station fails to work due to uncontrollable factors, it may further cause user equipment in the field to lose connection and not capable of transmitting data. In other words, when the base station lacks stability, there is bound to be a chance of data transmission interruption.

### SUMMARY

Accordingly, this disclosure provides a radio access network system solving the problem described above.

According to one or more embodiment of this disclosure, a radio access network system comprises: at least one first radio unit and at least one second radio unit. The at least one first radio unit has a first frequency band, and the at least one second radio unit has a second frequency band, wherein the frequency range of the first frequency band and the frequency range of the second frequency band do not overlap with each other, and a first coverage range of the first frequency band in an area and a second coverage range of the second frequency band in the area partially overlap with each other.

In view of the above description, when a radio unit (or base station) in one frequency band fails to work properly due to uncontrollable factors, the radio access network system of one or more embodiments may use a radio unit (or base station) in another frequency band as a backup through multi-band coverage overlapping design, so as to prevent the user equipment from completely losing the wireless signal connection and achieve high availability of connections in the area. Moreover, since the first frequency band and the second frequency band have different frequency ranges, there will be no interference resulted from signal with same frequency. Through the multi-band coverage mechanism described above, stable wireless signal quality may be provided for user equipment. Therefore, the probability of transmission interruption during data transmission between premise machine and user equipment may be greatly reduced.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a radio access network system according to an embodiment of the present disclosure;

FIG. 2 is a schematic diagram illustrating the coverage of each frequency band according to an embodiment of the present disclosure; and

FIG. 3 is a block diagram of a radio access network system according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

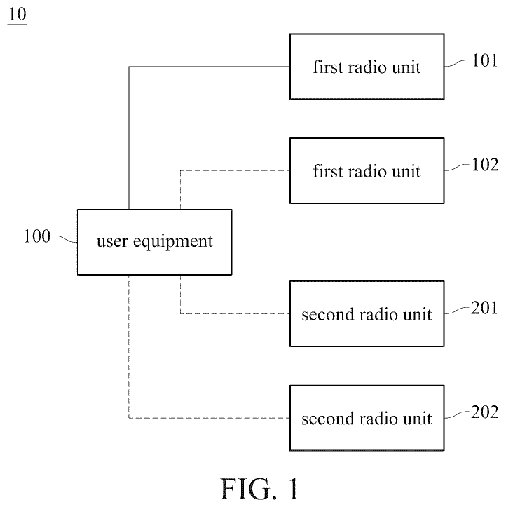

Please refer to FIG. 1 which is a block diagram of a radio access network system according to an embodiment of the present disclosure. As shown in FIG. 1, the radio access network system 10 includes a user equipment 100, a plurality of first radio units 101 and 102, and a plurality of second radio units 201 and 202. FIG. 1 exemplarily shows two first radio units and two second radio units, but the number of each of the first radio unit and the second radio unit may also be equal to one or greater than two, and the numbers of the first radio unit and the second radio unit may be the same or different from each other, which is not limited by the present disclosure.

The user equipment 100 may be customer premise equipment (CPE). Furthermore, when the radio access network system 10 is applied in an environment such as a factory or an office, the user equipment 100 may be a premise machine (for example, a processing machine), a desktop computer, or other fixed equipment located at a fixed location. The user equipment 100 is an optional component.

The first radio units 101 and 102 may be radio units deployed near the antenna or integrated into the antenna. The second radio units 201 and 202 may be radio units deployed near the same antenna or integrated into the same antenna. The first radio units 101 and 102 and the second radio units 201 and 202 may convert radio signals transmitted to and from the antenna into digital signals for transmission.

Each of the first radio units 101 and 102 has a first frequency band, and each of the second radio units 201 and 202 has a second frequency band. The frequency range of the first frequency band and the frequency range of the second frequency band do not overlap with each other. For example, the frequency range of the first frequency band may be 4600 MHZ to 4700 MHZ, and the frequency range of the second frequency band may be 4800 MHz to 4900 MHZ.

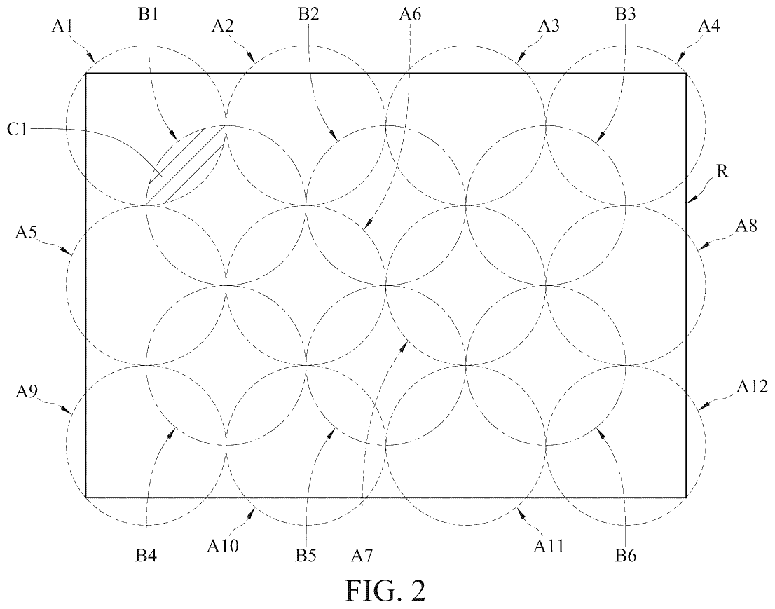

Furthermore, the first coverage range of the first frequency band in an area and the second coverage range of the second frequency band in the area partially overlap with each other. The first coverage range and the second coverage range may be regarded as the radio signal transmission and reception range of the antenna. Please refer to FIG. 2 along with FIG. 1, FIG. 2 is a schematic diagram illustrating the coverage of each frequency band according to an embodiment of the present disclosure. In FIG. 2, the thicker dashed line is used to represent the coverage of the first frequency band, and the thinner dashed line is used to represent the coverage of the second frequency band.

FIG. 2 shows 12 first coverage ranges A1 to A12 and 6 second coverage ranges B1 to B6. The number of first coverage ranges and second coverage ranges shown in FIG. 2 is merely an example, and the present disclosure is not limited thereto. Corresponding to FIG. 1, the first coverage range A1 may correspond to the coverage range of the first radio unit 101, and the first coverage range A2 may correspond to the coverage range of the first radio unit 102. Similarly, the second coverage range B1 may correspond to the coverage range of the second radio unit 201, and the second coverage range B2 may correspond to the coverage range of the second radio unit 202. In other words, in the example of FIG. 2, the radio access network system may have 12 first radio units and 6 second radio units.

As shown in FIG. 2, in the area R, the first coverage range A1 and the second coverage range B1 partially overlap each other, the first coverage range A2 and the second coverage range B1 partially overlap each other, and the first coverage range A2 and the second coverage range B2 partially overlap each other. The arrangement of other first coverage ranges and second coverage ranges is similar and is not described again herein. In other words, each second coverage range may be used to cover a portion of the first coverage range and a portion not covered by the first coverage range. Area R may be an environment such as a factory or office as described above.

Moreover, the first coverage range A1 of the first radio unit 101 and the first coverage range A2 of the first radio unit 102 are adjacent to each other and do not overlap. The second coverage range B2 of the second radio unit 201 and the second coverage range B2 of the second radio unit 202 are adjacent to each other and do not overlap. FIG. 2 shows that a first coverage range is adjacent to another first coverage range, and a second coverage range is adjacent to another second coverage range, but the present disclosure is not limited to the adjacent design shown in FIG. 2. However, through this adjacent design, fewer radio units may be used to form the coverage range covering the area R.

In addition, the user equipment 100 may be disposed within the overlapping portion between the first coverage range and the second coverage range, that is, at the junction of the coverage range of the first radio unit and the coverage range of the second radio unit. Taking FIG. 2 as an example, there is an overlapping portion C1 between the first coverage range A1 and the second coverage range B1, and the user equipment 100 may be located in the overlapping portion C1. Furthermore, the user equipment 100 may be located at a fixed location.

In addition, FIG. 2 exemplarily illustrates the coverage ranges as circular, and each coverage range has the same size, but the coverage ranges may also be implemented in different shapes and may have different sizes.

In view of the above description, when a radio unit (or base station) in one frequency band fails to work properly due to uncontrollable factors, the radio access network system of one or more embodiments may use a radio unit (or base station) in another frequency band as a backup through multi-band coverage overlapping design, so as to prevent the user equipment from completely losing the wireless signal connection and achieve high availability of connections in the area. Moreover, since the first frequency band and the second frequency band have different frequency ranges, there will be no interference resulted from signal with same frequency. Through the multi-band coverage mechanism described above, stable wireless signal quality may be provided for user equipment. Therefore, the probability of transmission interruption during data transmission between premise machine and user equipment may be greatly reduced.

In addition, the one with a lower frequency range among the first frequency band and the second frequency band may have a larger coverage range. Taking FIG. 2 as an example, the frequency range of the first frequency band is lower than the frequency range of the second frequency band, and the total area of the 12 first coverage ranges may be larger than the total area of the 6 second coverage ranges shown in FIG. 2. Therefore, the user equipment 100 may be used to connect to the first radio unit when both the first radio unit and the second radio unit are operating normally (have no function failure). For example, assuming that the user equipment 100 is located in the overlapping portion C1, and the first radio unit corresponding to the first coverage range A1 and the second radio unit corresponding to the second coverage range B1 are both operating normally, the user equipment 100 may connect to the first radio unit corresponding to the first coverage range A1. In other words, among the multiple normally operating radio units that the user equipment 100 can detect, the user equipment 100 may preferentially connect to the radio unit with the lower frequency range and the strongest signal strength. Therefore, when the user equipment 100 is within the range covered by the first frequency band and the corresponding first radio unit is operating normally, the user equipment 100 may preferentially transmit data through the network of the first radio unit. At this time, the second radio unit is not connected to the user equipment 100, and the second radio unit may enter a standby backup state.

In another embodiment, the user equipment 100 is disposed in the overlapping portion C1, and the user equipment 100 may be configured to scan a frequency band from low frequency to high frequency, and connect to a radio unit that is first scanned among the first radio unit and the second radio unit. In other words, the user equipment 100 may scan the frequency band from low frequency to high frequency to connect to the radio unit that is operating normally and has the lowest frequency band. Therefore, when the user equipment 100 does not scan any of the first radio units corresponding to the 12 first coverage ranges as shown in FIG. 2 but scans the second radio unit, the user equipment 100 may connect to the second radio unit. For example, assuming that the user equipment 100 is located in the overlapping portion C1, and the user equipment 100 cannot detect the first radio unit 101 in the first coverage range A1 but can detect the second radio unit 201 corresponding to the second coverage range B1, the user equipment 100 may connect to the second radio unit 201. Furthermore, when the first radio unit 101 fails to operate normally due to uncontrollable factors, the user equipment 100 may lose connection and be unable to transmit data. At this time, because there is a second radio unit 201 in a standby backup state in the field that can provide connection services, and the user equipment 100 is in the signal coverage range of the second radio unit 201 (for example, the second coverage range B1), after the user equipment 100 loses the connection with the first radio unit 101, the user equipment 100 may automatically scan other connectable frequency bands in the environment. After the user equipment 100 scans the frequency band of the second radio unit 201, the user equipment 100 may initiate a connection and registration behavior to the second radio unit 201, and then resume data transmission.

When the first radio unit 101 resumes normal operation, the first radio unit 101 may enter the standby backup state, and the user equipment 100 continues to use the connection function provided by the second radio unit 201. In addition, the user equipment 100 may also scan other connectable frequency bands in the environment regularly or irregularly. Therefore, when the user equipment 100 scans the frequency band of the first radio unit 101, the user equipment 100 may switch to connect to the first radio unit 101. At this time, the second radio unit 201 enters the standby backup state. In other words, when the user equipment fails in connection or data transmission in the original frequency band, the user equipment can use a detection mechanism to scan the available frequency bands in the environment and automatically switch to the new frequency band; when the original frequency band resumes normal operation, the user equipment may switch to the original frequency band and continue data transmission.

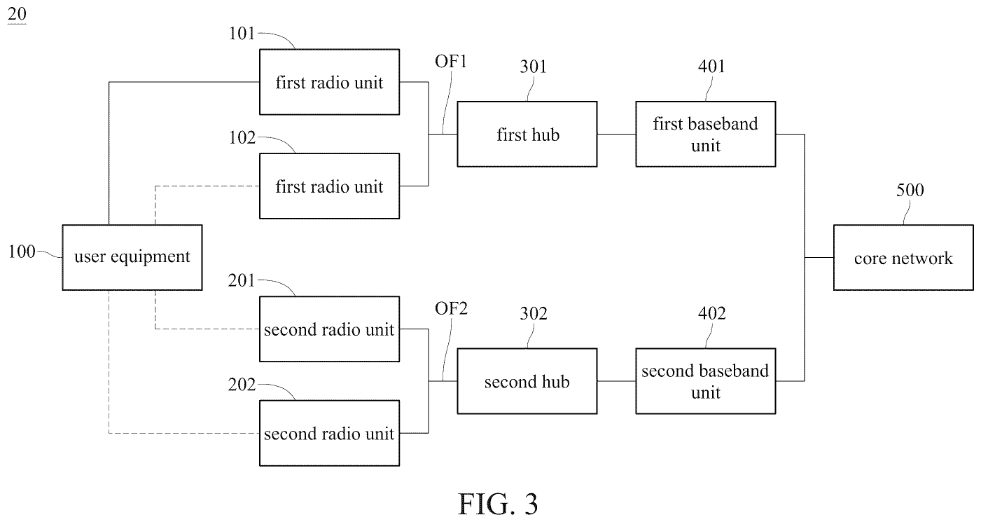

Please refer to FIG. 3 which is a block diagram of a radio access network system according to another embodiment of the present disclosure. As shown in FIG. 3, the radio access network system 20 includes a user equipment 100, a plurality of first radio units 101 and 102, a plurality of second radio units 201 and 202, a first hub 301, a second hub 302, a first baseband unit (BBU) 401, a second baseband unit 402 and a core network 500.

The first hub 301 and the second hub 302 may be remote radio unit hubs (rHub). The first hub 301 is connected to the first radio units 101 and 102 through the first optical fiber OF1, and the second hub 302 is connected to the second radio units 201 and 202 through the second optical fiber OF2.

The first baseband unit 401 is connected to the first hub 301, the second baseband unit 402 is connected to the second hub 302, and the first baseband unit 401 and the second baseband unit 402 are connected to the core network 500. The core network 500 may be a 5G core network.

Assuming that the first radio unit 101 is the radio unit connected to the user equipment 100, then the first baseband unit 401 may receive the digital signal from the core network 500 and output the digital signal to the first radio unit 101 through the first hub 301 and the first optical fiber OF1. In addition, the signal output by the user equipment 100 may also be output to the first hub 301 through the first radio unit 101 and the first optical fiber OF1, and then the first hub 301 outputs the signal to the core network 500 through the first baseband unit 401. When the user equipment 100 is connected to the second radio unit, the corresponding operation may be the same as that of the first radio unit 101, first hub 301, first baseband unit 401 and core network 500 as described above, and the description is not repeated herein.

In view of the above description, when a radio unit (or base station) in one frequency band fails to work properly due to uncontrollable factors, the radio access network system of one or more embodiments may use a radio unit (or base station) in another frequency band as a backup through multi-band coverage overlapping design, so as to prevent the user equipment from completely losing the wireless signal connection and achieve high availability of connections in the area. Moreover, since the first frequency band and the second frequency band have different frequency ranges, there will be no interference resulted from signal with same frequency. Through the multi-band coverage mechanism described above, stable wireless signal quality may be provided for user equipment. Therefore, the probability of transmission interruption during data transmission between premise machine and user equipment may be greatly reduced.

In an embodiment of the present disclosure, the radio access network system may be applied to a system composed of a 5G private network and a 5G small base station.

What is claimed is:

1. A radio access network system, comprising:
at least one first radio unit having a first frequency band; and
at least one second radio unit having a second frequency band,
wherein a frequency range of the first frequency band and a frequency range of the second frequency band do not overlap with each other, and a first coverage range of the first frequency band in an area and a second coverage range of the second frequency band in the area partially overlap with each other.

2. The radio access network system of claim 1, wherein a number of the at least one first radio unit is plural, a number of the at least one second radio unit is plural, the first coverage range corresponding to one of the at least one first radio unit and the first coverage range corresponding to another one of the at least one first radio unit are adjacent to each other, and the second coverage range corresponding to one of the at least one second radio unit and the second coverage range corresponding to another one of the at least one second radio unit are adjacent to each other.

3. The radio access network system of claim 2, wherein a total area of the first coverage range corresponding to the at least one first radio unit is larger than a total area of the second coverage range corresponding to the at least one second radio unit.

4. The radio access network system of claim 1, wherein the frequency range of the first frequency band is lower than the frequency range of the second frequency band.

5. The radio access network system of claim 4, further comprising:
a user equipment disposed within an overlapping portion between the first coverage range and the second coverage range, and configured to connect to the at least one first radio unit when the at least one first radio unit and the at least one second radio unit both operate normally.

6. The radio access network system of claim 4, further comprising:
a user equipment disposed within an overlapping portion between the first coverage range and the second coverage range, and configured to scan a frequency band from low frequency to high frequency, and connect to a radio unit that is first scanned among the at least one first radio unit and the at least one second radio unit.

7. The radio access network system of claim 1, further comprising:
a user equipment disposed within an overlapping portion between the first coverage range and the second coverage range, and configured to scan a frequency band from low frequency to high frequency, and connect to the at least one second radio unit that is scanned when the at least one first radio unit has function failure.

8. The radio access network system of claim 1, wherein the at least one second radio unit is configured to enter a standby backup state when the at least one second radio unit is not connected to a user equipment.

9. The radio access network system of claim 1, further comprising:
a first hub connected to the at least one first radio unit through a first optical fiber; and
a second hub connected to the at least one second radio unit through a second optical fiber.

10. The radio access network system of claim 9, further comprising:
a first baseband unit connected to the first hub and configured to connect to a core network; and
a second baseband unit connected to the second hub and configured to connect to the core network.
